(19) United States
(12) Patent Application Publication
(10) Pub. No.: US 2008/0152998 A1
(43) Pub. Date: Jun. 26, 2008

(54) SECONDARY BATTERY

(75) Inventors: Takashi Murakami, Fukushima (JP); Yosuke Konishi, Fukushima (JP); Tadahiko Kubota, Kanagawa (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 11/866,875

(22) Filed: Oct. 3, 2007

(30) Foreign Application Priority Data
Oct. 16, 2006 (JP) P2006-281529

(51) Int. Cl. H01M 10/00

(52) U.S. Cl. 429/200; 429/338; 428/188

(57) ABSTRACT

A secondary battery is disclosed. The secondary battery includes a positive electrode, a negative electrode, a separator intervening therebetween and an electrolytic solution. The secondary battery has an open circuit voltage in a fully charged state per a pair of the positive electrode and the negative electrode in the range of 4.25 V or more and not more than 6.00 V, and the electrolytic solution contains at least one kind of an aromatic compound represented by the following formula (1):

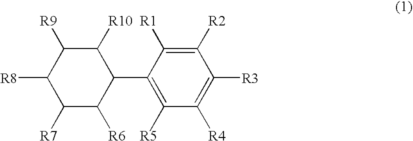

wherein R1 to R10 each independently represents hydrogen, a halogen group, an alkyl group, a halogenated alkyl group, an aryl group or a halogenated aryl group.

### CROSS REFERENCES TO RELATED APPLICATIONS

The present application claims priority to Japanese Patent Application JP 2006-281529 filed in the Japanese Patent Office on Oct. 16, 2006, the entire contents of which is being incorporated herein by reference.

### BACKGROUND

The present application relates to a secondary battery having an open circuit voltage in a fully charged state per a pair of a positive electrode and a negative electrode of 4.25 V or more.

Owing to a remarkable development of portable electronic technology in recent years, electronic appliances such as mobile phones and notebook personal computers have started to be recognized as a basic technology supporting a high-level information society. Also, research and development on high functionalization of these electronic appliances are energetically advanced, and the consumed electric power of these electronic appliances increases steadily in proportion thereto. On the other hand, these electronic appliances are required to be driven over a long period of time, and a high energy density of secondary battery as a drive power source has been inevitably desired. Also, in view of consideration of the environment, the prolongation of a cycle life has been desired.

From the viewpoints of occupied volume and mass of a battery to be built in an electronic appliance, it is desired that the energy density of the battery is high as far as possible. Since a lithium ion secondary battery has an excellent energy density, it is the present state that the lithium ion secondary battery is built in almost all of appliances.

Usually, in lithium ion secondary batteries, lithium cobaltate and a carbon material are used as a positive electrode and a negative electrode, respectively, and an operating voltage is in the range of from 4.2 V to 2.5 V. The matter that in a single cell, a terminal voltage can be increased to 4.2 V largely relies upon excellent electrochemical stability of non-aqueous electrolytic solution materials or separators.

On the other hand, in related-art lithium ion secondary batteries capable of operating at 4.2 V at maximum, positive electrode active substances to be used for a positive electrode, for example, lithium cobaltate utilize merely about 60% of a capacity with respect to the theoretical capacity thereof. For that reason, by further increasing a charge voltage, it is theoretically possible to utilize the residual capacity. Actually, it is known that by making the voltage at the charge to 4.25 V or more, a high energy density is revealed (see, for example, WO 03/019713 (Patent Document 1)).

However, when a non-aqueous electrolytic solution secondary battery is overcharged, excessive release of lithium takes place in a positive electrode with the progress of the overcharged state, whereas excessive occlusion of lithium takes place in a negative electrode, and metallic lithium is deposited as the case may be. Any of the positive electrode or the negative electrode in such a state is placed in a thermally unstable state, and decomposition of the electrolytic solution and abrupt heat generation are caused, whereby abnormal heat generation of the battery occurs, leading to a problem that the safety of the battery is impaired. Such a problem becomes especially remarkable with an increase in the energy density of the non-aqueous electrolytic solution secondary battery.

In order to solve the foregoing problems, it was proposed in, for example, JP-A-7-302614 (Patent Document 2) that a small amount of an aromatic compound is added as an additive in an electrolytic solution, thereby enabling one to secure the safety against the overcharge. According to the proposal in this Patent Document 2, a carbon material is used in a negative electrode, and an aromatic compound having a molecular weight of not more than 500 and having a π-electron orbit having a reversible oxidation reduction potential in a potential nobler than a positive electrode potential at the full charge, such as anisole derivatives, is used as the additive of the electrolytic solution. Such an aromatic compound prevents the overcharge, whereby the battery is protected.

However, in a battery in which the over voltage is set up exceeding 4.25 V, in particular, an oxidizing atmosphere in the vicinity of the positive electrode surface is strengthened. As a result, there was a problem that a separator coming into physical contact with the positive electrode at the continuous charge is oxidized and decomposed, whereby the battery becomes unsafe due to an abrupt current rise.

Also, in the case of using an overcharge preventing agent, there was a problem that a reaction proceeds a little step by step at the usual charge and discharge or at the high-temperature storage, thereby lowering the performance of the battery. In particular, in the case where the over voltage is set up exceeding 4.25 V, this problem becomes remarkable because the reaction is accelerated.

Thus, it is desirable to provide a safe secondary battery which even when the over voltage is set up exceeding 4.25 V, is free from the generation of a problem in a continuous charge characteristic and does not cause breakage or the like at the overcharge.

### SUMMARY

A secondary battery according to an embodiment is a secondary battery including a positive electrode, a negative electrode, a separator intervening therebetween and an electrolytic solution, wherein the secondary battery has an open circuit voltage in a fully charged state per a pair of the positive electrode and the negative electrode in the range of 4.25 V or more and not more than 6.00 V, and the electrolytic solution contains at least one kind of an aromatic compound represented by the following formula (1).

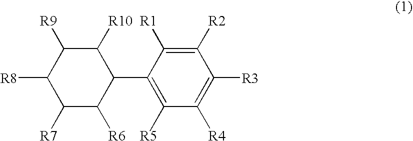

In the foregoing formula (1), R1 to R10 each independently represents hydrogen, a halogen group, an alkyl group, a halogenated alkyl group, an aryl group or a halogenated aryl group.

In the secondary battery according to an embodiment, by making an open circuit voltage at the full charge fall within the range of 4.25 V or more and not more than 6.00 V, a high energy density can be obtained. Also, since at least one kind of an aromatic compound having the foregoing structure is added in an electrolytic solution, such an aromatic compound causes oxidative polymerization in an overcharge state to form a film with high resistivity on a surface of an active substance thereby suppressing an overcharge current, and as a result, the progress overcharge can be retarded prior to the secondary battery becomes in a dangerous state.

Additional features and advantages are described herein, and will be apparent from, the following Detailed Description and the figures.

### BRIEF DESCRIPTION OF THE FIGURES

FIG. 1 is a cross-sectional view showing a configuration of a secondary battery according to an embodiment.

FIG. 2 is a cross-sectional view enlargedly showing a part of a wound electrode body in the secondary battery as shown in FIG. 1.

### DETAILED DESCRIPTION

The present application is described in further described in further detail below with reference to the accompanying drawings according to an embodiment.

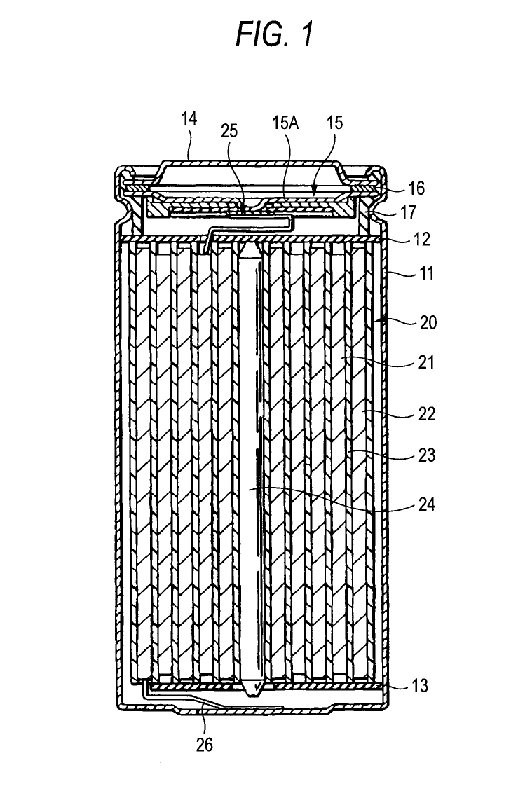

FIG. 1 shows a cross-sectional structure of a secondary battery according to an embodiment. This secondary battery is a so-called lithium ion secondary battery using lithium as an electrode reactant, in which the capacity of a negative electrode is expressed by a capacity component due to occlusion and release of lithium. This secondary battery is of a so-called cylindrical type and has a wound electrode 20 in which a pair of a stripe-shaped positive electrode 21 and a stripe-shaped negative electrode 22 is wound via a separator 23 in the inside of a substantially hollow, columnar battery can 11. The battery can 11 is configured of, for example, nickel-plated iron, and one end portion thereof is closed, with the other end portion being opened. A pair of insulating plates 12, 13 is respectively arranged in the inside of the battery can 11 perpendicularly to a winding circumferential surface so as to sandwich the wound electrode body 20 therebetween.

A battery lid 14, a safety valve mechanism 15 provided in the inside of this battery lid 14 and a positive temperature coefficient element (PTC element) 16 are caulked and installed in the open end portion of the battery can 11 via a gasket 17, and the inside of the battery can 11 is sealed. The battery lid 14 is, for example, configured of the same material as in the battery can 11. The safety valve mechanism 15 is electrically connected to the battery lid 14 via the positive temperature coefficient element 16. When an inner pressure of the battery rises to a fixed value or more due to an inner short circuit, heating from the outside, or the like, a disk plate (electric power lead-through plate) 15A turns round, thereby disconnecting the electrical connection between the battery lid 14 and the wound electrode body 20. The disk plate 15A configures a current shut-down sealing body together with the positive temperature coefficient element 16. When the temperature rises, the positive temperature coefficient element 16 controls the current due to an increase of its resistivity value and prevents the abnormal heat generation caused due to a large current. The gasket 17 is configured of, for example, an insulating material, and a surface thereof is coated with asphalt.

For example, a center pin 24 is inserted in a center of the wound electrode body 20. A positive electrode lead 25 made of aluminum or the like is connected to the positive electrode 21 of the wound electrode body 20, and a negative electrode lead 26 made of nickel or the like is connected to the negative electrode 22. The positive electrode lead 25 is welded to the safety valve mechanism 15 and electrically connected to the battery lid 14, and the negative electrode lead 26 is welded and electrically connected to the battery can 11.

<Positive Electrode>

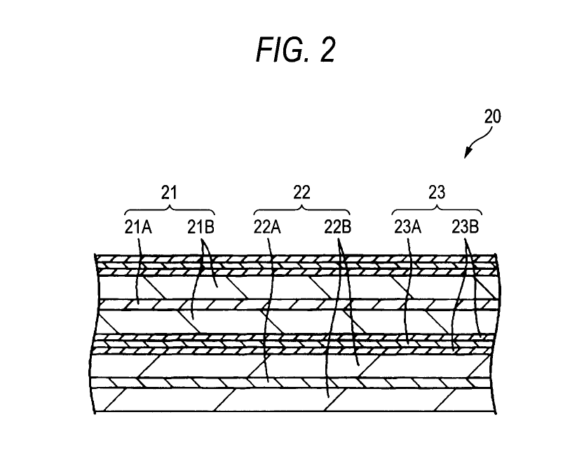

FIG. 2 enlargedly shows a part of the wound electrode body 20 as shown in FIG. 1. As shown in FIG. 2, for example, the positive electrode 21 has a structure in which a positive electrode active substance layer 21B is provided on both surfaces of a positive electrode collector 21A having a pair of opposing surfaces to each other. While illustration is omitted, the positive electrode active substance layer 21B may be provided on only one surface of the positive electrode collector 21A. The positive electrode collector 21A is configured of, for example, a metal foil such as an aluminum foil. The positive electrode active substance layer 21B is configured to contain, for example, one kind or plural kinds of a positive electrode material capable of occluding and releasing lithium as the positive electrode active substance and contain a conductive agent such as graphite and a binder such as polyvinylidene fluoride as the need arises.

The positive electrode material capable of occluding and releasing lithium contains a lithium composite oxide having a stratified rock-salt type structure containing lithium, cobalt and oxygen which is expressed by an average composition represented by the following formula (8). This is because the energy density can be increased. Specific examples of such a lithium composite oxide include LiaCoO2 (a≅1) and Lic1Co1-c2Nic2O2 (c1≅1, 0≦c2≦0.5).

LirCo(1−s)M1sO(2−t)Fu (8)

In the foregoing formula (8), M1 represents at least one kind selected from the group consisting of nickel, manganese, magnesium, aluminum, boron, titanium, vanadium, chromium, iron, copper, zinc, molybdenum, tin, calcium, strontium and tungsten; and r, s, t and u are values falling within the ranges of (0.8≦r≦1.2), (0≦s≦0.5), (−0.1≦t≦0.2) and (0≦u≦0.1), respectively. The composition of lithium varies with the state of charge and discharge, and the value of r represents a value in a fully charged state.

The positive electrode material may be further mixed with other positive electrode material in addition to the foregoing lithium composite oxide. Examples of other positive electrode material include other lithium oxides, lithium sulfides and other lithium-containing interlayer compounds [examples thereof include lithium composite oxides having a stratified rock-salt type structure which is expressed by an average composition represented by the following formula (9) or (10), lithium composite oxides having a spinel type structure which is expressed by an average composition represented by the following formula (11) and lithium composite phosphates having an olivine type structure represented by the following formula (12)].

LifMn(1−g−h)NigM2hO(2−j)Fk (9)

In the foregoing formula (9), M2 represents at least one kind selected from the group consisting of cobalt, magnesium, aluminum, boron, titanium, vanadium, chromium, iron, copper, zinc, zirconium, molybdenum, tin, calcium, strontium and tungsten; and f, g, h, j and k are values falling within the ranges of (0.8≦f≦1.2), (0<g<0.5), (0≦h≦0.5), ((g+h)<1), (−0.1≦j≦0.2) and (0≦k≦0.1), respectively. The composition of lithium varies with the state of charge and discharge, and the value of f represents a value in a fully charged state.

LimNi(1−n)M3nO(2−p)Fq (10)

In the foregoing formula (10), M3 represents at least one kind selected from the group consisting of cobalt, manganese, magnesium, aluminum, boron, titanium, vanadium, chromium, iron, copper, zinc, molybdenum, tin, calcium, strontium and tungsten; and m, n, p and q are values falling within the ranges of (0.8≦m≦1.2), (0.005≦n≦0.5), (−0.1≦p≦0.2) and (0≦q≦0.1), respectively. The composition of lithium varies with the state of charge and discharge, and the value of m represents a value in a fully charged state.

LivMn(2−w)M4wOxFy (11)

In the foregoing formula (11), M4 represents at least one kind selected from the group consisting of cobalt, nickel, magnesium, aluminum, boron, titanium, vanadium, chromium, iron, copper, zinc, molybdenum, tin, calcium, strontium and tungsten; and v, w, x and y are values falling within the ranges of (0.9≦v≦1.1), (0≦w≦0.6), (3.7≦x≦4.1) and (0≦y≦0.1), respectively. The composition of lithium varies with the state of charge and discharge, and the value of v represents a value in a fully charged state.

LizM5PO4 (12)

In the foregoing formula (12), M5 represents at least one kind selected from the group consisting of cobalt, manganese, iron, nickel, magnesium, aluminum, boron, titanium, vanadium, niobium, copper, zinc, molybdenum, calcium, strontium, tungsten and zirconium; and z is a value falling within the range of (0.9≦z≦1.1). The composition of lithium varies with the state of charge and discharge, and the value of z represents a value in a fully charged state.

The positive electrode material may be a composite particle obtained by coating the surface of a core particle composed of any one of the lithium-containing compounds represented by the foregoing formulae (8) to (12) with a fine particle composed of any one of these lithium-containing compounds (see Japanese Patent No. 3543437). By using such a composite particle, higher electrode filling properties and cycle characteristic are obtained. Examples of a method for coating the surface of a core particle composed of a lithium-containing compound with a fine particle composed of a lithium-containing compound include a high-speed rotational impact blending method. The “high-speed rotational impact blending method” as referred to herein is a method in which a mixture obtained by uniformly mixing a powder and a fine particle is dispersed in a high-speed gas stream and an impact operation is repeated, thereby imparting mechanical thermal energy to the powder. According to this action, the mixture becomes in a state that the fine particle is uniformly deposited on the powder surface, and the powder is subjected to surface modification. The core particle and the fine particle may be a lithium-containing compound of the same kind or may be a lithium-containing compound different from each other.

A ratio of an average particle size r1 of the composite particle to an average particle size r2 of the core particle (r1/r2) is preferably (1.01≦r1/r2≦2); and a ratio of an average particle size r3 of the fine particle to the average particle size r2 of the core particle (r3/r2) is more preferably (r3/r2≦1/5). However, the term “average particle size” as referred to herein means a median size, namely a particle size with respect to 50% of accumulated distribution.

<Negative Electrode>

The negative electrode 22 has a structure in which a negative electrode active substance layer 22B is provided on both surfaces of a negative electrode collector 22A having a pair of opposing surfaces to each other. While illustration is omitted, the negative electrode active substance layer 22B may be provided on only one surface of the negative electrode collector 22A. The negative electrode collector 22A is configured of, for example, a metal foil such as a copper foil.

The negative electrode active substance layer 22B is configured to contain, for example, one kind or plural kinds of negative electrode materials capable of occluding and releasing lithium as the negative electrode active substance and contain the same binder as in the positive electrode active substance layer 21B as the need arises.

Examples of the negative electrode material capable of occluding and releasing lithium include carbon materials such as non-graphitizing carbon, easily graphitizing carbon, graphite, pyrolytic carbons, cokes, glassy carbons, organic high molecular baked materials, carbon fiber and activated carbon. Of these, examples of the cokes include pitch coke, needle coke and petroleum coke. The “organic high molecular compound baked material” as referred to herein means a carbonized material obtained by baking a high molecular material such as phenol resins and furan resins at an appropriate temperature, a part of which is classified into non-graphitizing carbon or easily graphitizing carbon. These carbon materials are preferable from the viewpoints that a change in the crystal structure caused at the charge and discharge is very small, that a high charge and discharge capacity can be obtained and that a satisfactory cycle characteristic can be obtained. Graphite is especially preferable from the viewpoints that its electrochemical equivalent is large and that a high energy density can be obtained. Furthermore, the non-graphitizing carbon is preferable from the viewpoint that an excellent cycle characteristic is obtained. Moreover, one having a low charge and discharge potential, specifically one having a charge and discharge potential close to lithium metal is preferable from the viewpoint that it is possible to realize a high energy density of the battery with ease.

As the negative electrode material, a material capable of occluding and releasing lithium and containing, as a constitutional element, at least one kind among metal elements and semi-metal elements is also exemplified. This is because by using such a material, a high energy density can be obtained. In particular, the use of such a material together with the carbon material is more preferable because not only a high energy density can be obtained, but an excellent cycle characteristic can be used. This negative electrode material may be a single material of a metal element or a semi-metal element or an alloy or compound thereof. Also, the negative electrode material may be one having a phase of one or plural kinds of these materials in at least a part thereof. In addition to plural kinds of metal elements, the alloy may contain one or plural kinds of metal elements and one or plural kinds of semi-metal elements or may contain a non-metal element. Examples of a texture of the alloy include a solid solution, an eutectic (eutectic mixture), an intermetallic compound and a texture where plural kinds thereof coexist.

Examples the metal element or semi-metal element constituting the negative electrode material include magnesium, boron, aluminum, gallium, indium, silicon, germanium, tin, lead, bismuth, cadmium, silver, zinc, hafnium, zirconium, yttrium, palladium and platinum. These may be crystalline or amorphous.

Among the metal elements or semi-metal elements, metal elements or semi-metal elements belonging to the 4B group of the short period type periodic table are preferable; and at least one of silicon and tin is especially preferable. This is because silicon and tin have an ability to occlude and release lithium and are able to obtain a high energy density.

Examples of alloys of tin which are used in the negative electrode material include alloys containing tin and, as a second constitutional element, at least one kind selected from the group consisting of silicon, nickel, copper, iron, cobalt, manganese, zinc, indium, silver, titanium, germanium, bismuth, antimony and chromium. Examples of alloys of silicon which are used in the negative electrode material include alloys containing, as a second constitutional element other than silicon, at least one kind selected from the group consisting of tin, nickel, copper, iron, cobalt, manganese, zinc, indium, silver, titanium, germanium, bismuth, antimony and chromium.

Examples of the compound of tin or the compound of silicon include compounds containing oxygen or carbon, and the compound of tin or the compound of silicon may contain the foregoing second constitutional element in addition to tin or silicon.

As the negative electrode material, other metal compounds or high molecular materials are further exemplified. Examples of other metal compound include oxides such as MnO2, V2O5 and V6O13; sulfides such as NiS and MoS; and lithium nitrides such as LiN3. Examples of the high molecular material include polyacetylene and polypyrrole.

In this secondary battery, the electrochemical equivalent of the negative electrode material capable of occluding and releasing lithium is larger than the electrochemical equivalent of the positive electrode 21, whereby lithium metal is not deposited on the negative electrode 22 on the way of charge.

<Separator>

The separator 23 partitions the positive electrode 21 and the negative electrode 22 from each other and makes a lithium ion pass therethrough while preventing the generation of a short circuit of current caused due to the contact of the both electrodes. It is preferable that this separator 23 is configured of a porous membrane made of a synthetic resin or a ceramic containing polyethylene and at least one kind of polypropylene, polyvinylidene fluoride, polytetrafluoroethylene, Al2O3 and SiO2. According to this, it is possible to suppress oxidative destruction of the separator coming into physical contact with the positive electrode at the continuous charge and prevent an abrupt current rise. The separator 23 may be a porous membrane prepared by mixing polyethylene and at least one kind of polypropylene and polytetrafluoroethylene or may be a porous membrane made of polyethylene, polypropylene and polytetrafluoroethylene having Al2O3, polyvinylidene fluoride and SiO2 coated thereon. The separator 23 may be of a structure where plural kinds of porous membranes made of polyethylene, polypropylene and polytetrafluoroethylene are laminated. Such a porous membrane is preferable because it has an excellent short-circuit preventing effect and is able to enhance the safety of the battery owing to a shut-down effect.

The separator is impregnated with an electrolytic solution which is a liquid electrolyte. The electrolytic solution can be gelled by a method such as addition of a polymer or fumed silica and crosslinking with a dissolved monomer. The gelled electrolyte can be used for the separator while making a microporous membrane, a cloth or non-woven fabric, a piercing plastic sheet, an electrode or the like as a support. Besides, the gelled electrolyte can also be used as the separator without using a support.

<Electrolytic Solution>

The electrolytic solution contains a solvent, an electrolyte salt dissolved in this solvent and an additive. The electrolytic solution contains at least one kind of an aromatic compound represented by the following formula (1) as the additive. This is because in an overcharge state, such an aromatic compound causes oxidative polymerization to form a film with high resistivity on a surface of an active substance, thereby suppressing an overcharge current. As a result, the progress of overcharge can be retarded prior to the battery becomes in a dangerous state.

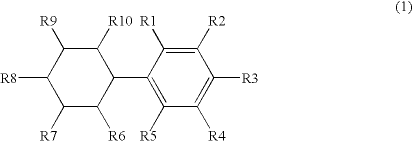

In the foregoing formula (1), R1 to R10 each independently represents hydrogen, a halogen group, an alkyl group, a halogenated alkyl group, an aryl group or a halogenated aryl group. It is preferable that in the aromatic compound represented by the foregoing formula (1), at least one of R1 to R10 represents a halogen group. This is because the oxidation potential of the substance increases, and usual influences at the charge and discharge can be minimized.

In the formula (1), the halogen group may be any of a fluorine group, a bromine group, an iodine group or a chlorine group, with a fluorine group being preferable. When a fluorine group is present, the oxidation reduction potential can be increased. The alkyl group is preferably a methyl group, an ethyl group, a t-butyl group or a t-pentyl group. The halogenated alkyl group is preferably a trifluoromethyl group, a pentafluoroethyl group or a hexafluoropropyl group. The aryl group is preferably a phenyl group or a benzyl group. The halogenated aryl group is preferably a monofluorophenyl group, a difluorophenyl group, a trifluorophenyl group, a tetra-fluorophenyl group, a perfluorophenyl group, a monofluorobenzyl group, a difluorobenzyl group, a trifluorobenzyl group, a tetrafluorobenzyl group or a perfluorobenzyl group.

The aromatic compound represented by the formula (1) is preferably an aromatic compound represented by the following formula (2).

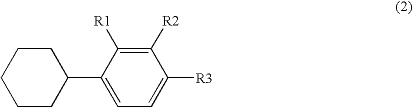

In the foregoing formula (2), at least one of R1 to R3 represents a halogen group. The halogen group may be any of a fluorine group, a bromine group, an iodine group or a chlorine group, with a fluorine group being preferable. Specific examples of the aromatic compound represented by the formula (2) include 1-cyclohexyl-2-fluorobenzene, 1-cyclohexyl-3-fluorobenzene, 1-cyclohexyl-4-fluorobenzene, 1,2-difluoro-4-cyclohexylbenzene, cyclohexylbenzene, 1,4-dicyclohexylbenzene, 1-bromo-2-cyclohexylbenzene and 1-bromo-4-cyclohexylbenzene. Of these, 1-cyclohexyl-2-fluorobenzene, 1-cyclohexyl-3-fluorobenzene, 1-cyclohexyl-4-fluorobenzene and 1,2-difluoro-4-cyclohexylbenzene are preferable; and 1-cyclohexyl-2-fluorobenzene and 1-cyclohexyl-4-fluorobenzene are more preferable.

The content of the aromatic compound represented by the formula (1) or (2) preferably falls within the range of 0.1% by mass or more and not more than 20% by mass, and more preferably falls within the range of 0.1% by mass or more and not more than 10% by mass in the electrolytic solution. This is because when the content of the aromatic compound represented by the formula (1) or (2) is less than this range, the effect for suppressing the overcharge is not sufficient, whereas even when it exceeds this range, the aromatic compound is excessively decomposed on the positive electrode at the high-temperature cycle, and the charge and discharge efficiency is lowered.

It is preferred to use a solvent containing a cyclic carbonic ester as the solvent in the electrolytic solution. This is because by suppressing the decomposition of an ionic complex on the negative electrode, the cycle characteristic can be enhanced. Examples of the cyclic carbonic ester include a vinylene carbonate based compound represented by the following formula (3), an ethylene carbonate and a propylene carbonate based compound represented by the following formula (4). Though these compounds may be used singly or in admixture, they are preferably used in admixture because the cycle characteristic can be enhanced.

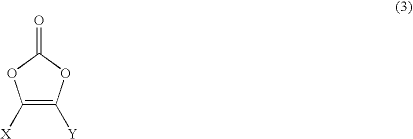

In the foregoing formula (3), X and Y each independently represents an electron withdrawing group selected from the group consisting of hydrogen, an alkyl group, a halogen group, a cyano group and a nitro group.

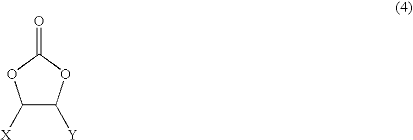

In the foregoing formula (4), X and Y each independently represents an electron withdrawing group selected from the group consisting of hydrogen, an alkyl group, a halogen group, a cyano group and a nitro group.

Specific examples of the compound represented by the formula (3) include vinylene carbonate and 4,5-dimethylvinylene carbonate.

Specific examples of the compound represented by the formula (4) include ethylene carbonate, propylene carbonate, 4-fluoroethylene carbonate and 4,5-difluoroethylene carbonate.

In addition to the foregoing cyclic carbonic ester, it is preferred to mix and use a chain carbonic ester such as diethyl carbonate, dimethyl carbonate, ethylmethyl carbonate and methylpropyl carbonate as the solvent. This is because according to this, high ionic conductivity can be obtained.

Besides, examples of the solvent include butylenes carbonate, γ-butyrolactone, γ-valerolactone, 1,2-dimethoxyethane, tetrahydrofuran, 2-methyltetrahydrofuran, 1,3-dioxolane, 4-methyl-1,3-dioxolane, methyl acetate, methyl propionate, acetonitrile, glutalonirile, adiponitrile, methoxyacetonitrile, 3-methoxypropionitirle, N,N-dimethylformamide, N-methylpyrrolidinone, N-methyloxazolidinone, N,N-dimethylimidazolidinone, nitromethane, nitroethane, sulfolane, dimethyl sulfoxide and trimethyl phosphate.

The foregoing solvents may be used singly or in admixture of two or more kinds thereof.

The content of the cyclic carbonic ester preferably falls within the range of 10% by mass or more and not more than 70% by mass, and more preferably falls within the range of 20% by mass or more and not more than 60% by mass in the electrolytic solution. This is because when the content of the cyclic carbonic ester is too low, the effect for suppressing the decomposition reaction of an ionic metal complex is not sufficient, whereas when it is too high, the cyclic carbonic ester is excessively decomposed on the negative electrode, and the charge and discharge efficiency is lowered. With respect to the cyclic carbonic ester, the content of the vinylene carbonate based compound represented by the formula (3) preferably falls within the range of 0.1% by mass or more and not more than 10% by mass in the electrolytic solution; and the content of the ethylene carbonate based compound represented by the formula (4) preferably falls within the range of 0.1% by mass or more and not more than 30% by mass in the electrolytic solution.

It is preferable that the electrolytic solution in an embodiment according to the application contains LiPF6 as an electrolyte salt. This is because by using LiPF6, the ionic conductivity of the electrolytic solution can be increased.

The concentration of LiPF6 preferably falls within the range of 0.1 mole/kg or more and not more than 2.0 moles/kg in the electrolytic solution. This is because the ionic conductivity can be more increased within this range.

In addition to LiF6, the electrolytic solution may contain other electrolyte salt as the electrolyte salt. Examples of other electrolyte salt include a compound represented by the following formula (5).

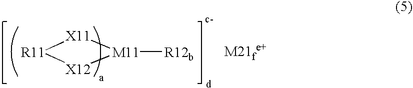

In the foregoing formula (5),

R11 represents a —C(═O)—R21—C(═O)— group (wherein R21 represents an alkylene group, a halogenated alkylene group, an arylene group or a halogenated arylene group), a —C(═O)—C(R23)(R24)— group (wherein R23 and R24 each represents an alkyl group, a halogenated alkyl group, an aryl group or a halogenated aryl group), or a —C(═O)—C(═O)— group;

R12 represents a halogen group, an alkyl group, a halogenated alkyl group, an aryl group or a halogenated aryl group;

X11 and X12 each represents oxygen or sulfur;

M11 represents a transition metal or an element belonging to the 3B group, 4B group or 5B group of the short period type periodic table;

M21 represents an element belonging to the 1A group or 2A group of the short period type periodic group or aluminum;

a represents an integer of from 1 to 4;

b represents an integer of from 0 to 8; and

c, d, e and f each represents an integer of from 1 to 3.

Examples of the compound represented by the formula (5) include lithium bisoxalate borate (LiBOB) represented by the following formula (13) and lithium difluorooxalate borate (LiFOB) represented by the following formula (14).

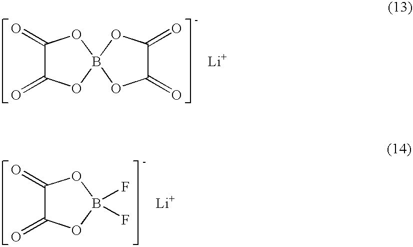

When lithium bisoxalate borate (LiBOB) is used, its content preferably falls within the range of 0.1% by mass or more and not more than 20% by mass relative to the electrolytic solution. When lithium difluorooxalate borate (LiFOB) is used, its content preferably falls within the range of 0.1% by mass or more and not more than 30% by mass relative to the electrolytic solution.

As other electrolyte salt, a chain compound represented by the following formula (6) is also exemplified.

LiN(CmF2m+1SO2_)(CnF2n+1SO2_) (6)

In the foregoing formula (6), m and n each represents an integer of 1 or more.

Examples of the compound represented by the formula (6) include lithium bis(trifluoromethanesulfonyl)imide [LiN(CF₃SO₂)₂], lithium bis(pentafluoroethanesulfonyl)imide [LiN(C2F5SO₂)₂], lithium (trifluoromethanesulfonyl)(pentafluoroethanesulfonyl)imide [LiN(CF₃ SO₂)(C2F5 SO₂)], lithium (trifluoromethanesulfonyl)(heptafluoropropanesulfonyl)imide [LiN(CF3SO2)(C3F7SO2)] and lithium (trifluoromethane-sulfonyl)(nonafluorobutanesulfonyl)imide [LiN(CF3SO2)(C4F9SO2)].

The content of the compound represented by the formula (6) preferably falls within the range of 0.1% by mass or more and not more than 30% by mass, and more preferably falls within the range of 0.3% by mass or more and not more than 20% by mass relative to the electrolytic solution.

As other electrolyte salt, a cyclic compound represented by the following general formula (7) is also exemplified.

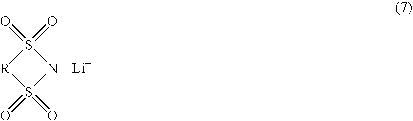

In the foregoing formula (7), R represents a linear or branched perfluoroalkylene group having from 2 to 4 carbon atoms.

An Example of the compound represented by the formula (7) includes perfluoropropane-1,3-disulfonylimide lithium.

The content of the compound represented by the formula (7) preferably falls within the range of 0.1% by mass or more and not more than 30% by mass, and more preferably falls within the range of 0.3% by mass or more and not more than 20% by mass relative to the electrolytic solution.

Examples of other electrolyte salt than the compounds represented by the foregoing formulae (5) to (7) include LiBF4, LiAsF6, LiClO4, LiB(C6H5)4, LiCH3SO3, LiCF3SO3, LiC(SO2CF3)3, LiAlCl4, LiSiF6, LiCl, difluoro[oxolate-O,O′]lithium borate, 1,2-perfluoroethanedisulfonylimide lithium and LiBr. The content of such other electrolyte salt preferably falls within the range of 0.1% by mass or more and not more than 30% by mass, and more preferably falls within the range of 0.3% by mass or more and not more than 20% by mass relative to the electrolytic solution.

These other electrolyte salts may be used singly or in admixture of two or more kinds thereof.

The secondary battery according to an embodiment is designed so as to have an open circuit voltage (namely, a battery voltage) at the full charge falling within the range of 4.25 V or more and not more than 6.00 V, and preferably falling within the range of 4.25 V or more and not more than 4.60 V. Thus, in comparison with a battery having an open circuit voltage at the full charge of 4.20 V, even when the positive electrode active substance is identical, the amount of lithium to be released per unit mass is high. Accordingly, the amounts of the positive electrode active substance and the negative electrode active substance are adjusted, and a higher energy density is obtained.

<Manufacturing Method>

The secondary battery according to an embodiment can be, for example, manufactured in the following manner.

First of all, the positive electrode can be manufactured in the following manner. For example, the foregoing positive electrode active substance, conductive agent and binder are mixed to prepare a positive electrode mixture, and the positive electrode mixture is dispersed in a solvent such as N-methyl-2-pyrrolidone to prepare a positive electrode mixture slurry in a paste state. Next, the positive electrode mixture slurry is coated on the positive electrode collector 21A, the solvent is dried, and the resulting positive electrode collector 21A is compression molded by using a roll pressing machine or the like to form the positive electrode active substance layer 21B. There is thus prepared the positive electrode 21.

Also, the negative electrode can be manufactured in the following manner. For example, the negative electrode active substance and the binder are mixed to prepare a negative electrode mixture, and the negative electrode mixture is dispersed in a solvent such as N-methyl-2-pyrrolidone to prepare a negative electrode mixture slurry in a paste state. Next, the negative electrode mixture slurry is coated on the negative electrode collector 22A, the solvent is dried, and the resulting negative electrode collector 22A is compression molded by using a roll pressing machine or the like to form the negative electrode active substance layer 22B. There is thus prepared the negative electrode 22.

Subsequently, the positive electrode lead 25 is installed in the positive electrode collector 21A by means of welding or the like, and the negative electrode lead 26 is also installed in the negative electrode collector 22A by means of welding or the like. Thereafter, the positive electrode 21 and the negative electrode 22 are wound via the separator 23; and not only a tip portion of the positive electrode lead 25 is welded to the safety valve mechanism 15, but a tip portion of the negative electrode 26 is welded to the battery can 11. The wound positive electrode 21 and negative electrode 22 are sandwiched by a pair of the insulating plates 12, 13 and contained in the inside of the battery can 11. After containing the positive electrode 21 and the negative electrode 22 in the inside of the battery can 11, the electrolytic solution is injected into the inside of the battery can 11 and dipped into the separator 23. Thereafter, the battery lid 14, the safety valve mechanism 15 and the positive temperature coefficient element 16 are caulked and fixed to the open end portion of the battery can 11 via the gasket 17. There is thus formed the secondary battery as shown in FIG. 1.

In the foregoing secondary battery, when charge is performed, for example, a lithium ion is released from the positive electrode active substance layer 21B and occluded in the negative electrode active substance layer 22B via the electrolytic solution. Also, when discharge is performed, for example, a lithium ion is released from the negative electrode active substance layer 22B and occluded in the positive electrode active substance layer 21B via the electrolytic solution.

In the foregoing embodiment, since the open circuit voltage at the full charge is made to fall within the range of 4.25 V or more and not more than 6.00 V, a high energy density can be obtained. Also, the electrolytic solution contains at least one kind of an aromatic compound represented by the following formula (1), and therefore, in an overcharge state, such an aromatic compound causes oxidative polymerization to form a film with high resistivity on a surface of an active substance, thereby suppressing an overcharge current. As a result, the progress of overcharge can be retarded prior to the battery becomes in a dangerous state.

Furthermore, by making the separator contain polyethylene and at least one kind of polypropylene, polyvinylidene fluoride, polytetrafluoroethylene, Al₂O3 and SiO2, it is possible to suppress oxidative destruction of the separator coming into physical contact with the positive electrode at the continuous charge and prevent an abrupt current rise from occurring. According to this, not only the energy density can be increased, but a continuous charge characteristic can be enhanced, and safety can be enhanced even at the overcharge.

In particular, by making the content of the aromatic compound represented by the formula (1) fall within the range of 0.1% by mass or more and not more than 10% by mass in the electrolytic solution, a high-temperature cycle characteristic can be enhanced.

While the present application has been described with reference to the foregoing embodiment, it should not be construed that the application is limited to this embodiment, and various changes and modifications can be made therein. For example, in the foregoing embodiment, while the secondary battery having a wound structure has been described, the application can be similarly applied to secondary batteries having a structure in which a positive electrode and a negative electrode are folded or a structure in which a positive electrode and a negative electrode are superimposed. In addition thereto, the application can also be applied to secondary batteries of a so-called coin type, button type, square shape type or laminate film type or the like.

Also, in the foregoing embodiment, while the case of using an electrolytic solution has been described, the application can also be applied to the case of using other electrolyte. An Example of other electrolyte includes an electrolyte in a so-called gel state in which an electrolytic solution is held by a high molecular compound.

Furthermore, in the foregoing embodiment, a so-called lithium ion secondary battery in which the capacity of a negative electrode is expressed by a capacity component due to occlusion and release of lithium has been described. However, the application can be similarly applied to a so-called lithium metal secondary battery in which lithium metal is used as a negative electrode active substance and a capacity of a negative electrode is expressed by a capacity component due to deposition and dissolution of lithium; or a secondary battery in which by making the charge capacity of a negative electrode material capable of occluding and releasing lithium smaller than the charge capacity of a positive electrode, the capacity of a negative electrode includes a capacity component due to occlusion and release of lithium and a capacity component due to deposition and dissolution of lithium and is expressed by the sum thereof.

### EXAMPLES

<Preparation of Battery>

The secondary battery as shown in FIG. 1 was prepared. First of all, 94% by mass of a lithium composite oxide as a positive electrode active substance, 3% by mass of ketjen black (amorphous carbon powder) as a conductive agent and 3% by mass of polyvinylidene fluoride as a binder were mixed, and the mixture was dispersed in N-methyl-2-pyrrolidone as a solvent to form a positive electrode mixture slurry. Next, the positive electrode mixture slurry was uniformly coated on both surfaces of the positive electrode collector 21A made of a stripe-shaped aluminum foil having a thickness of 20 μm and dried, followed by compression molding to form the positive electrode active substance layer 21B. There was thus prepared the positive electrode 21. Thereafter, the aluminum-made positive electrode lead 25 was installed in one end of the positive electrode collector 21A.

Also, 90% by mass of a granular graphite powder having an average particle size of 30 μm as a negative electrode active substance and 10% by mass of polyvinylidene fluoride as a binder were mixed, and the mixture was dispersed in N-methyl-2-pyrrolidone as a solvent to form a negative electrode mixture slurry. Next, the negative electrode mixture slurry was uniformly coated on both surfaces of the negative electrode collector 22A made of a stripe-shaped copper foil having a thickness of 15 μm and dried, followed by compression molding to form the negative electrode active substance layer 22B. There was thus prepared the negative electrode 22. On that occasion, the design was made in such a manner that the amount of the positive electrode active substance and the amount of the negative electrode active substance were adjusted so as to obtain a value of an open circuit voltage (namely, a battery voltage) at the full charge as shown in each of the following tables of the Examples. Subsequently, the nickel-made negative electrode lead 26 was installed in one end of the negative electrode collector 22A.

After preparing each of the positive electrode 21 and the negative electrode 22, the separator 23 made of a microporous membrane was prepared; the negative electrode 22, the separator 23, the positive electrode 21 and the separator 23 were laminated in this order; and the laminate was wound several times in a spiral form to prepare the wound electrode body 20 of a jelly roll type having an outer diameter of 17.8 mm. With respect to the composition of the separator, one as shown in each of the following tables was employed.

After preparing the wound electrode body 20, the wound electrode body 20 was sandwiched by a pair of the insulating plates 12, 13; not only the negative electrode lead 26 was welded to the battery can 11, but the positive electrode lead 25 was welded to the safety valve mechanism 15; and the wound electrode body 20 was contained in the inside of the nickel-plated iron-made battery can 11. Subsequently, an electrolytic solution was injected into the inside of the battery can 11 by means of a vacuum system. As the electrolytic solution, one prepared by mixing ethylene carbonate, propylene carbonate, dimethyl carbonate and ethylmethyl carbonate in a mass ratio of ethylene carbonate/propylene carbonate/dimethyl carbonate/ethylmethyl carbonate of 25/5/65/5 and adding an additive as shown in each of the following tables was used. LiPF6 was used as an electrolyte salt, and a concentration of LiPF6 in the electrolytic solution was set up at 1.0 mole/kg.

Thereafter, the battery can 11 was caulked with the battery lid 24 via the gasket 27, thereby preparing a cylindrical secondary battery having a diameter of 18 mm and a height of 65 mm.

<Evaluation of Battery>

The thus prepared secondary battery was measured with respect to continuous charge characteristic, overcharge characteristic and high-temperature cycle characteristic in the following manners.

(1) Continuous Charge Characteristic:

In a thermostat set up at 60° C., after performing constant-current charge at a constant current of 1,000 mA until the voltage reached a prescribed value, and constant-voltage charge was performed at a prescribed voltage. On that occasion, a time at which a change of the charge current was observed (a leakage current was generated) was determined.

(2) Overcharge Characteristic:

Constant-current, constant-voltage charge was performed at a prescribed voltage and 1,000 mA, and a cell in a fully charged state was charged at 2,400 mA until the voltage reached 18 V. On that occasion, a maximum attained temperature of the surface temperature of the cell was determined.

(3) High-Temperature Cycle Characteristic:

Constant-current, constant-voltage charge was performed at a prescribed voltage and 1,000 mA in a thermostat at 40° C.; subsequently, constant-current discharge was performed at a constant current of 2,000 mA until the battery voltage reached 3 V; and this charge and discharge was repeated. Thus, the high-temperature cycle characteristic was determined in term of a discharge capacity retention in 300 cycles to the discharge capacity at the first cycle [(discharge capacity in 100 cycles)/(discharge capacity at the first cycle)×100%].

### Examples 1-1-1 to 1-9-6

In Examples 1-1-1 to 1-4-6, 100% of LiCoO2 was used as the lithium composite oxide in the positive electrode; a triple-layered separator of polypropylene/polyethylene/polypropylene (PP/PE/PP triple-layered separator) was used as the separator; and an additive as shown in Table 1 was added in the electrolytic solution. An upper limit of the charge voltage was set up at from 4.25 to 4.60 V.

In Examples 1-5-1 to 1-8-6, secondary batteries were prepared in the same manner as in Examples 1-1-1 to 1-4-6, except for using a polyethylene separator (PE separator) as the separator.

In Examples 1-9-1 to 1-9-6, secondary batteries were prepared in the same manner as in Examples 1-1-1 to 1-4-6, except for using cyclohexylbenzene as the additive.

### Comparative Examples 1-1-1 to 1-3-9

In Comparative Examples 1-1-1 to 1-1-6, secondary batteries were prepared in the same manner as in Examples 1-1-1 to 1-4-6, except for not adding the additive in the electrolytic solution.

In Comparative Examples 1-2-1 to 1-2-6, secondary batteries were prepared in the same manner as in Examples 1-5-1 to 1-8-6, except for not adding the additive in the electrolytic solution.

In Comparative Examples 1-3-1 to 1-3-8, secondary batteries were prepared in the same manner as in Examples 1-1-1 to 1-4-6, except for adjusting the amount of each of the positive electrode active substance and the negative electrode active substance to regulate the open circuit voltage at the full charge at 4.20 V. In Comparative Example 1-3-9, a secondary battery was prepared in the same manner as in Comparative Examples 1-1-1 to 1-1-6, except for adjusting the amount of each of the positive electrode active substance and the negative electrode active substance to regulate the open circuit voltage at the full charge at 4.20 V.

Results obtained by evaluating characteristics of each of the secondary batteries of Examples 1-1-1 to 1-9-6 and Comparative Examples 1-1-1 to 1-3-9 are shown in the following Table 1.

TABLE 1

| | | | | | | | High- |
|---|---|---|---|---|---|---|---|
| | | | | | | Attained | temperature |
| | Upper limit of | | | | | temperature at | cycle |
| | charge voltage | | | Concentration | Continuous | the overcharge | characteristic |
| | (V) | Separator | Additive | (% by mass) | charge time (hr) | (° C.) | (%) |
| Example 1-1-1 | 4.25 | PP/PE/PP | 1-Cyclohexyl-2-fluoro- | 2 | 500 hours or more | 63 | 91 |
| Example 1-1-2 | 4.30 | | benzene | | 500 hours or more | 67 | 88 |
| Example 1-1-3 | 4.35 | | | | 500 hours or more | 70 | 85 |
| Example 1-1-4 | 4.40 | | | | 400 | 71 | 69 |
| Example 1-1-5 | 4.50 | | | | 300 | 71 | 48 |
| Example 1-1-6 | 4.60 | | | | 150 | 50 | 35 |
| Example 1-2-1 | 4.25 | PP/PE/PP | 1-Cyclohexyl-3-fluoro- | 2 | 500 hours or more | 65 | 88 |
| Example 1-2-2 | 4.30 | | benzene | | 500 hours or more | 68 | 86 |
| Example 1-2-3 | 4.35 | | | | 500 hours or more | 71 | 83 |
| Example 1-2-4 | 4.40 | | | | 400 | 72 | 67 |
| Example 1-2-5 | 4.50 | | | | 300 | 71 | 45 |
| Example 1-2-6 | 4.60 | | | | 150 | 51 | 32 |
| Example 1-3-1 | 4.25 | PP/PE/PP | 1-Cyclohexyl-4-fluoro- | 2 | 500 hours or more | 66 | 89 |
| Example 1-3-2 | 4.30 | | benzene | | 500 hours or more | 68 | 87 |
| Example 1-3-3 | 4.35 | | | | 500 hours or more | 71 | 84 |
| Example 1-3-4 | 4.40 | | | | 400 | 71 | 68 |
| Example 1-3-5 | 4.50 | | | | 300 | 71 | 48 |
| Example 1-3-6 | 4.60 | | | | 150 | 51 | 33 |
| Example 1-4-1 | 4.25 | PP/PE/PP | 1,2-Difluoro-4-cyclohexyl- | 2 | 500 hours or more | 69 | 89 |
| Example 1-4-2 | 4.30 | | beznene | | 500 hours or more | 71 | 87 |
| Example 1-4-3 | 4.35 | | | | 500 hours or more | 76 | 84 |
| Example 1-4-4 | 4.40 | | | | 400 | 74 | 69 |
| Example 1-4-5 | 4.50 | | | | 300 | 70 | 50 |
| Example 1-4-6 | 4.60 | | | | 150 | 50 | 31 |
| Example 1-5-1 | 4.25 | PE | 1-Cyclohexyl-2-fluoro- | 2 | 200 | 63 | 83 |
| Example 1-5-2 | 4.30 | | benzene | | 80 | 67 | 72 |
| Example 1-5-3 | 4.35 | | | | 30 | 70 | 61 |
| Example 1-5-4 | 4.40 | | | | 20 | 69 | 40 |
| Example 1-5-5 | 4.50 | | | | 5 | 69 | 15 |
| Example 1-5-6 | 4.60 | | | | 5 | 48 | 1 |
| Example 1-6-1 | 4.25 | PE | 1-Cyclohexyl-3-fluoro- | 2 | 200 | 63 | 81 |
| Example 1-6-2 | 4.30 | | benzene | | 80 | 67 | 70 |
| Example 1-6-3 | 4.35 | | | | 30 | 71 | 58 |
| Example 1-6-4 | 4.40 | | | | 20 | 72 | 37 |
| Example 1-6-5 | 4.50 | | | | 5 | 72 | 14 |
| Example 1-6-6 | 4.60 | | | | 5 | 45 | 1 |
| Example 1-7-1 | 4.25 | PE | 1-Cyclohexyl-4-fluoro- | 2 | 200 | 63 | 83 |
| Example 1-7-2 | 4.30 | | benzene | | 80 | 67 | 72 |
| Example 1-7-3 | 4.35 | | | | 30 | 70 | 61 |
| Example 1-7-4 | 4.40 | | | | 20 | 68 | 38 |
| Example 1-7-5 | 4.50 | | | | 5 | 65 | 15 |
| Example 1-7-6 | 4.60 | | | | 5 | 47 | 1 |
| Example 1-8-1 | 4.25 | PE | 1,2-Difluoro-4-cyclohexyl- | 2 | 200 | 63 | 85 |
| Example 1-8-2 | 4.30 | | beznene | | 80 | 67 | 73 |
| Example 1-8-3 | 4.35 | | | | 30 | 69 | 62 |
| Example 1-8-4 | 4.40 | | | | 20 | 68 | 41 |
| Example 1-8-5 | 4.50 | | | | 5 | 64 | 16 |
| Example 1-8-6 | 4.60 | | | | 5 | 47 | 1 |
| Example 1-9-1 | 4.25 | PP/PE/PP | Cyclohexylbenzene | 2 | 500 hours or more | 69 | 77 |
| Example 1-9-2 | 4.30 | | | | 500 hours or more | 70 | 73 |
| Example 1-9-3 | 4.35 | | | | 500 hours or more | 90 | 68 |
| Example 1-9-4 | 4.40 | | | | 400 | 81 | 59 |
| Example 1-9-5 | 4.50 | | | | 300 | 64 | 35 |
| Example 1-9-6 | 4.60 | | | | 150 | 50 | 24 |
| Comparative | 4.25 | PP/PE/PP | Nil | | 500 hours or more | 71 | 89 |
| Example 1-1-1 | | | | | | | |
| Comparative | 4.30 | | | | 500 hours or more | 73 | 86 |
| Example 1-1-2 | | | | | | | |
| Comparative | 4.35 | | | | 500 hours or more | Burned | 83 |
| Example 1-1-3 | | | | | | | |
| Comparative | 4.40 | | | | 400 | Burned | 70 |
| Example 1-1-4 | | | | | | | |
| Comparative | 4.50 | | | | 300 | Burned | 49 |
| Example 1-1-5 | | | | | | | |
| Comparative | 4.60 | | | | 150 | 52 | 36 |
| Example 1-1-6 | | | | | | | |
| Comparative | 4.25 | PE | Nil | | 200 | 63 | 84 |
| Example 1-2-1 | | | | | | | |
| Comparative | 4.3 | | | | 80 | 68 | 74 |
| Example 1-2-2 | | | | | | | |
| Comparative | 4.35 | | | | 30 | Burned | 62 |
| Example 1-2-3 | | | | | | | |
| Comparative | 4.4 | | | | 20 | Burned | 41 |
| Example 1-2-4 | | | | | | | |
| Comparative | 4.5 | | | | 5 | 61 | 15 |
| Example 1-2-5 | | | | | | | |
| Comparative | 4.6 | | | | 5 | 48 | 1 |
| Example 1-2-6 | | | | | | | |
| Comparative | 4.20 | PP/PE/PP | 1-Cyclohexyl-2-fluoro- | 2 | 500 hours or more | 50 | 95 |
| Example 1-3-1 | | | benzene | | | | |
| Comparative | | | 1-Cyclohexyl-3-fluoro- | | 500 hours or more | 52 | 94 |
| Example 1-3-2 | | | benzene | | | | |
| Comparative | | | 1-Cyclohexyl-4-fluoro- | | 500 hours or more | 52 | 94 |
| Example 1-3-3 | | | benzene | | | | |
| Comparative | | | 1,2-Difluoro-4- | | 500 hours or more | 52 | 94 |
| Example 1-3-4 | | | cyclohexylbeznene | | | | |
| Comparative | | PE | 1-Cyclohexyl-2-fluoro- | 2 | 500 hours or more | 51 | 94 |
| Example 1-3-5 | | | benzene | | | | |
| Comparative | | | 1-Cyclohexyl-3-fluoro- | | 500 hours or more | 52 | 94 |
| Example 1-3-6 | | | benzene | | | | |
| Comparative | | | 1-Cyclohexyl-4-fluoro- | | 500 hours or more | 52 | 94 |
| Example 1-3-7 | | | benzene | | | | |
| Comparative | | | 1,2-Difluoro-4- | | 500 hours or more | 52 | 94 |
| Example 1-3-8 | | | cyclohexylbeznene | | | | |

| | | | | | |
|---|---|---|---|---|---|
| Comparative | PP/PE/PP | Nil | 500 hours or more | 53 | 96 |
| Example 1-3-9 | | | | | |

It was noted from the comparison of Examples 1-1-1 to 1-9-6 with Comparative Examples 1-1-1 to 1-2-6 that by adding the additive in the electrolytic solution, even when the upper limit of the charge voltage is 4.25 V or more, the continuous charge time is long, the attained temperature at the overcharge is low, and the cycle characteristic is enhanced. It was confirmed from Comparative Examples 1-1-1 to 1-2-6 that in the case where the additive is not added, when the upper limit of the charge voltage exceeds 4.25 V, burning of cell was confirmed to take place.

Also, with respect to the additive, in Examples 1-1-1 to 1-1-6, Examples 1-5-1 to 1-5-6, Examples 1-3-1 to 1-3-6 and Examples 1-7-1 to 1-7-6 in which 1-cyclohexyl-2-fluorobenzene or 1-cyclohexyl-4-fluorobenzene is added in the electrolytic solution, both the attained temperature at the overcharge and the cycle characteristic were especially satisfactory.

Furthermore, it was noted from the comparison of Examples 1-1-1 to 1-4-6 with Examples 1-5-1 to 1-8-6 that in the batteries in which the additive is added by using the PE separator, in the case of performing the charge at 4.25 V or more, the high-temperature cycle characteristic was lowered, whereas in the batteries in which the additive is added by using the PP/PE/PP triple-layered separator, even in the case of performing the charge at an upper limit voltage of 4.25 V or more, the high-temperature cycle characteristic was not lowered.

### Examples 2-1-1 to 2-1-8

Secondary batteries were prepared in the same manners as in Example 1-5-3 and Example 1-7-3, except for changing the separator to be used to one as shown in the following Table 2. Results obtained by evaluating characteristics of each of the secondary batteries of Examples 2-1-1 to 2-1-8 are shown in the following Table 2.

TABLE 2

| | | | | | | | High- |
|---|---|---|---|---|---|---|---|
| | Upper limit | | | | | Attained | temperature |
| | of charge | | | | | temperature at | cycle |
| | voltage | | | Concentration | Continuous charge | the overcharge | characteristic |
| | (V) | Separator | Additive | (% by mass) | time (hr) | (° C.) | (%) |
| Example 2-1-1 | 4.35 | PP-blended PE | 1-Cyclohexyl-2-fluorobenzene | 2 | 500 hours or more | 70 | 79 |
| Example 2-1-2 | | | 1-Cyclohexyl-4-fluorobenzene | | 500 hours or more | 70 | 79 |
| Example 2-1-3 | | PTFE/PE/PTFE | 1-Cyclohexyl-2-fluorobenzene | | 500 hours or more | 71 | 77 |
| Example 2-1-4 | | | 1-Cyclohexyl-4-fluorobenzene | | 500 hours or more | 71 | 76 |
| Example 2-1-5 | | Al₂O₃-coated PE | 1-Cyclohexyl-2-fluorobenzene | | 500 hours or more | 69 | 78 |
| Example 2-1-6 | | | 1-Cyclohexyl-4-fluorobenzene | | 500 hours or more | 69 | 76 |
| Example 2-1-7 | | SiO₂-coated PE | 1-Cyclohexyl-2-fluorobenzene | | 500 hours or more | 70 | 75 |
| Example 2-1-8 | | | 1-Cyclohexyl-4-fluorobenzene | | 500 hours or more | 70 | 75 |
| Example 1-5-3 | 4.35 | PE | 1-Cyclohexyl-2-fluorobenzene | 2 | 30 | 70 | 61 |
| Example 1-7-3 | | | 1-Cyclohexyl-4-fluorobenzene | | 30 | 70 | 61 |

It is noted from Table 2 that in all of Examples 2-1-1 to 2-1-8 in which the PP-blended PE separator, the PTFE/PE/PTFE separator, the Al₂O₃-coated PE separator or the SiO₂-coated PE separator is used, an excellent continuous charge characteristic is revealed as compared with Example 1-5-3 and Example 1-7-3 using the PE separator. Also, other characteristics were equivalent.

Also, referring to Table 1, in the batteries in which the PE separator is used and 1-cyclohexyl-2-fluorobenzene or 1-cyclohexyl-4-fluorobenzene is added, in the case of performing the charge while controlling the upper limit voltage at 4.20 V, the high-temperature cycle characteristic was not lowered, whereas in the case of performing the charge at 4.25 V or more, the high-temperature cycle characteristic was lowered. However, in the case of using polyethylene and other substance than polyethylene (i.e., polypropylene, polyvinylidene fluoride, polytetrafluoroethylene, Al2O3 or SiO2) such as the PP/PE/PP triple-layered separator, the PP-blended PE separator, the PTFE/PE/PTFE separator, the Al₂O₃-coated PE separator and the SiO2-coated PE separator, even by performing the charge at an upper limit voltage of 4.25 V or more by adding 1-cyclohexyl-2-fluorobenzene or 1-cyclohexyl-4-fluorobenzene, the high-temperature cycle characteristic was not lowered.

That is, it was noted that by using the separator containing polyethylene and at least one kind of polypropylene, polyvinylidene fluoride, polytetrafluoroethylene, Al2O3 and SiO2, an effect for suppressing the attained temperature at the overcharge due to the additive such as 1-cyclohexyl-2-fluorobenzne can be obtained without lowering the high-temperature cycle characteristic, thereby making it possible to make both the cycle characteristic and the safety more compatible with each other.

### Examples 3-1-1- to 3-3-5

Secondary batteries were prepared in the same manner as in Example 1-1-3, except for changing the amount and kind of the additive to be added in the electrolytic solution as shown in the following Table 3. Results obtained by evaluating characteristics of each of the secondary batteries of Examples 3-1-1 to 3-3-5 are shown in the following Table 3.

TABLE 3

| | | | | | | | High- |
|---|---|---|---|---|---|---|---|
| | | | | | | Attained | temperature |
| | Upper limit of | | | | | temperature at | cycle |
| | charge voltage | | | Concentration | Continuous charge | the overcharge | characteristic |
| | (V) | Separator | Additive | (% by mass) | time (hr) | (° C.) | (%) |
| Example 3-1-1 | 4.35 | PP/PE/PP | 1-Cyclohexyl-2-fluorobenzene | 0.1 | 500 hours or more | 76 | 85 |
| Example 3-1-2 | | | | 0.5 | 500 hours or more | 73 | 83 |
| Example 3-1-3 | | | | 5 | 500 hours or more | 68 | 81 |
| Example 3-1-4 | | | | 10 | 500 hours or more | 64 | 75 |
| Example 3-1-5 | | | | 20 | 500 hours or more | 59 | 64 |
| Example 3-2-1 | 4.35 | PP/PE/PP | 1-Cyclohexyl-4-fluorobenzene | 0.1 | 500 hours or more | 78 | 85 |
| Example 3-2-2 | | | | 0.5 | 500 hours or more | 75 | 82 |
| Example 3-2-3 | | | | 5 | 500 hours or more | 70 | 81 |
| Example 3-2-4 | | | | 10 | 500 hours or more | 66 | 75 |
| Example 3-2-5 | | | | 20 | 500 hours or more | 60 | 63 |
| Example 3-3-1 | 4.35 | PP/PE/PP | 1-Cyclohexyl-2-fluorobenzene | 0.1 each | 500 hours or more | 75 | 85 |
| Example 3-3-2 | | | and | 1 each | 500 hours or more | 67 | 81 |
| Example 3-3-3 | | | 1-cyclohexyl-4-fluorobenzene | 5 each | 500 hours or more | 60 | 78 |
| Example 3-3-4 | | | | 10 each | 500 hours or more | 54 | 67 |
| Example 3-3-5 | | | | 20 each | 500 hours or more | 50 | 49 |

| | | | | | | |
|---|---|---|---|---|---|---|
| Comparative | 4.35 | PP/PE/PP | Nil | 500 hours or more | Burned | 83 |
| Example 1-1-3 | | | | | | |

It is noted from Table 3 that in all of Examples 3-1-1 to 3-2-5 in which 1-cyclohexyl-2-fluorobenzene or 1-cyclohexyl-4-fluorobenzene is added in an amount in the range of from 0.1 to 20% by mass in the electrolytic solution, satisfactory results were obtained as compared with Comparative Example 1-5-3 in which the additive is not added. Also, it was noted that in Examples 3-3-1 to 3-3-5 in which equal amounts of 1-cyclohexyl-2-fluorobenzene and 1-cyclohexyl-4-fluorobenzene are added in the electrolytic solution, when the concentration of each of these additives in the electrolytic solution falls within the range of from 0.1 to 10% by mass (from 0.2 to 20% by mass in total), nevertheless the retention of high-temperature cycle characteristic is 60% or more, the overcharge characteristic could be enhanced.

### Examples 4-1-1 to 4-2-5

Secondary batteries were prepared in the same manner as in Example 1-1-3 or Example 1-3-3, except for further adding a compound as shown in the following Table 4. Results obtained by evaluating characteristics of each of the secondary batteries of Examples 4-1-1 to 4-2-5 are shown in the following Table 4.

TABLE 4

| | Upper | | | | | | | | Attained | High- |
|---|---|---|---|---|---|---|---|---|---|---|
| | limit of | | | | | | Concen- | | temperature | temperature |
| | charge | | | Con- | Cyclic | Electro- | tration | Continuous | at the | cycle |
| | voltage | | | centration | carbonic | lyte | (% by | charge time | overcharge | characteristic |
| | (V) | Separator | Additive | (% by mass) | ester | salt | mass) | (hr) | (° C.) | (%) |
| Example 4-1-1 | 4.35 | PP/PE/PP | 1-Cyclohexyl-2- | 2 | VC | — | 2 | 500 hours | 66 | 88 |
| | | | fluorobenzene | | | | | or more | | |
| Example 4-1-2 | | | | | FEC | — | | 500 hours | 63 | 90 |
| | | | | | | | | or more | | |
| Example 4-1-3 | | | | | DFEC | — | | 500 hours | 64 | 88 |
| | | | | | | | | or more | | |
| Example 4-1-4 | | | | | — | LiBOB | | 500 hours | 63 | 90 |
| | | | | | | | | or more | | |
| Example 4-1-5 | | | | | — | LiTFSl | | 500 hours | 67 | 89 |
| | | | | | | | | or more | | |
| Example 4-2-1 | 4.35 | PP/PE/PP | 1-Cyclohexyl-4- | 2 | VC | — | 2 | 500 hours | 66 | 88 |
| | | | fluorobenzene | | | | | or more | | |
| Example 4-2-2 | | | | | FEC | — | | 500 hours | 64 | 89 |
| | | | | | | | | or more | | |
| Example 4-2-3 | | | | | DFEC | — | | 500 hours | 64 | 88 |
| | | | | | | | | or more | | |
| Example 4-2-4 | | | | | — | LiBOB | | 500 hours | 65 | 89 |
| | | | | | | | | or more | | |
| Example 4-2-5 | | | | | — | LiTFSl | | 500 hours | 67 | 87 |
| | | | | | | | | or more | | |

| | | | | | | | | |
|---|---|---|---|---|---|---|---|---|
| Example 1-1-3 | 4.35 | PP/PE/PP | 1-Cyclohexyl-2- | 2 | Nil | 500 hours | 70 | 85 |
| | | | fluorobenzene | | | or more | | |
| Example 1-3-3 | | | 1-Cyclohexyl-4- | | | 500 hours | 71 | 84 |
| | | | fluorobenzene | | | or more | | |

VC: Vinylene carbonate, FEC: Fluoroethylene carbonate, DFEC: Difluoroethylene carbonate, LiBOB: Lithium bisoxalate borate, LiTFSl: Lithium bistrifluoromethane sulfonimde

It was noted from Table 4 that in all of Examples 4-1-1 to 4-2-5, there is no problem regarding the continuous charge characteristic, the maximum attained temperature at the overcharge is lowered, and the high-temperature cycle characteristic can be enhanced.

### Examples 5-1-1 to 5-1-7

Secondary batteries were prepared in the same manner as in Example 1-1-3, except for changing the composition of the lithium composite oxide in the positive electrode to a mixture composition of lithium composite oxides as shown in the following Table 5. Results obtained by evaluating characteristics of each of the secondary batteries of Examples 5-1-1 to 5-1-7 are shown in the following Table 5.

TABLE 5

| | Upper | | | Con- | | | Attained | High- |
|---|---|---|---|---|---|---|---|---|
| | limit of | | | centra- | | | temperature | temperature |
| | charge | | | tion | | Continuous | at the | cycle |
| | voltage | | | (% by | | charge time | overcharge | characteristic |
| | (V) | Separator | Additive | mass) | Positive electrode | (Hr) | (° C.) | (%) |
| Example 5-1-1 | 4.35 | PP/PE/PP | 1-Cyclohexyl-2- | 2 | LiNiO₂ 20% + LiCoO₂ 80% | 500 hours | 68 | 86 |
| | | | fluorobenzene | | | or more | | |
| Example 5-1-2 | | | | | LiMnO₂ 20% + LiCoO₂ 80% | 500 hours | 65 | 80 |
| | | | | | | or more | | |
| Example 5-1-3 | | | | | LiNi_{0.5}Mn_{0.5}O₂ 20% + LiCoO₂ 80% | 500 hours | 59 | 91 |
| | | | | | | or more | | |
| Example 5-1-4 | | | | | LiNi_{0.33}Co_{0.33}Mn_{0.33}O₂ 20% + | 500 hours | 61 | 89 |
| | | | | | LiCoO₂ 80% | or more | | |
| Example 5-1-5 | | | | | LiNi_{0.5}Co_{0.2}Mn_{0.3}O₂ 20% + | 500 hours | 61 | 89 |
| | | | | | LiCoO₂ 80% | or more | | |
| Example 5-1-6 | | | | | LiMn₂O₄ 20% + LiCoO₂ 80% | 500 hours | 65 | 85 |
| | | | | | | or more | | |
| Example 5-1-7 | | | | | LiFePO₄ 20% + LiCoO₂ 80% | 500 hours | 66 | 87 |
| | | | | | | or more | | |
| Example 1-1-3 | 4.35 | PP/PE/PP | 1-Cyclohexyl-2- | 2 | LiCoO₂ 100% | 500 hours | 70 | 85 |
| | | | fluorobenzene | | | or more | | |

It was noted from Table 5 that in the case of any one of the positive electrodes as used in Examples 5-1-1 to 5-1-7, there is no problem regarding the continuous charge characteristic, the maximum attained temperature at the overcharge is lowered similar to Example 1-1-3, and the high-temperature cycle characteristic can be enhanced.

### Examples 6-1-1 to 6-1-3

Secondary batteries were prepared in the same manner as in Example 1-1-3 or Example 1-3-3, except for changing the kind of the additive to 1,4-dicyclohexylbenzne, 1-bromo-2-cyclohexylbenzene or 1-bromo-4-cyclohexylbenzene. Results obtained by evaluating characteristics of each of the secondary batteries of Examples 6-1-1 to 6-1-3 are shown in the following Table 6.

TABLE 6

| | | | | | | | High- |
|---|---|---|---|---|---|---|---|
| | | | | | | Attained | temperature |
| | Upper limit of | | | | | temperature at | cycle |
| | charge voltage | | | Concentration | Continuous charge | the overcharge | characteristic |
| | (V) | Separator | Additive | (% by mass) | time (hr) | (° C.) | (%) |
| Example 6-1-1 | 4.35 | PP/PE/PP | 1,4-Dicyclohexylbenznene | 2 | 500 hours or more | 80 | 67 |
| Example 6-1-2 | | | 1-Bromo-2-cyclohexylbenzene | | 500 hours or more | 78 | 72 |
| Example 6-1-3 | 4.35 | PP/PE/PP | 1-Bromo-4-cyclohexylbenzene | 2 | 500 hours or more | 78 | 70 |
| Example 1-1-3 | | | 1-Cyclohexyl-2-fluorobenzene | | 500 hours or more | 70 | 85 |
| Example 1-3-3 | | | 1-Cyclohexyl-4-fluorobenzene | | 500 hours or more | 71 | 84 |

| | | | | | | |
|---|---|---|---|---|---|---|
| Comparative | 4.35 | PP/PE/PP | Nil | 500 hours or more | Burned | 83 |
| Example 1-1-3 | | | | | | |

As is clear from Table 6, there were obtained results that in all of Examples 6-1-1 to 6-1-3 in which the kind of the additive is changed to 1,4-dicyclohexylbenzene, 1-bromo-2-cyclohexylbenzene and 1-bromo-4-cyclohexylbenzene, respectively, though there is no problem regarding the continuous charge characteristic and the maximum attained temperature at the overcharge is lowered, the high-temperature cycle characteristic is slightly inferior as compared with Example 1-1-3 (1-cyclohexyl-2-fluorobenzene) and Example 1-3-3 (1-cyclohexyl-4-fluorobenzene). It is thought to be caused due to the matter that the bromine group is liable to cause side reactions related to the deterioration of battery as compared with the fluorine group.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A secondary battery comprising:
a positive electrode;
a negative electrode;
a separator intervening therebetween; and
an electrolytic solution, wherein
the secondary battery has an open circuit voltage in a fully charged state per a pair of the positive electrode and the negative electrode in the range of 4.25 V or more and not more than 6.00 V, and
the electrolytic solution contains at least one kind of an aromatic compound represented by the following formula (1): 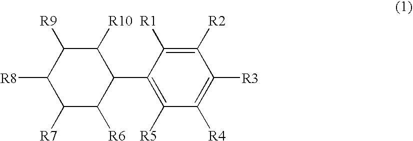
wherein R1 to R10 each independently represents hydrogen, a halogen group, an alkyl group, a halogenated alkyl group, an aryl group or a halogenated aryl group.

2. The secondary battery according to claim 1, wherein
the separator contains polyethylene and at least one kind of polypropylene, polyvinylidene fluoride, polytetrafluoroethylene, Al₂O₃ and SiO₂.

3. The secondary battery according to claim 1, wherein
at least one of R1 to R10 of the aromatic compound represented by the formula (1) represents a halogen group.

4. The secondary battery according to claim 1, wherein
the halogen group is a fluorine group.

5. The secondary battery according to claim 1, wherein
the aromatic compound represented by the formula (1) is an aromatic compound represented by the following formula (2): 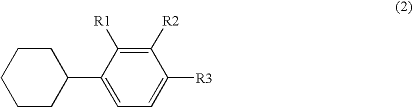
wherein at least one of R1 to R3 represents a halogen group.

6. The secondary battery according to claim 1, wherein
the electrolytic solution contains at least one kind of an aromatic compound represented by the formula (1) in an amount in the range of 0.1% by mass or more and not more than 20% by mass.

7. The secondary battery according to claim 1, wherein
the positive electrode contains, as a positive electrode active substance, a lithium composite oxide containing lithium, cobalt and oxygen.

8. The secondary battery according to claim 7, wherein
the positive electrode further contains, as a positive electrode active substance, a lithium composite oxide containing lithium and at least one of nickel and manganese.

9. The secondary battery according to claim 1, wherein
the electrolytic solution contains at least one kind of compounds represented by the following formulae (3) and (4): 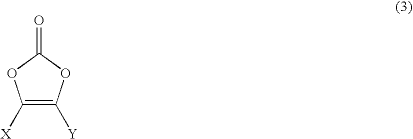
wherein X and Y each independently represents an electron withdrawing group selected from the group consisting of hydrogen, an alkyl group, a halogen group, a cyano group and a nitro group, and 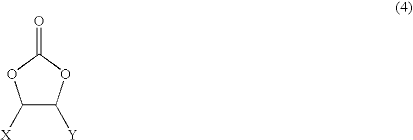
wherein X and Y each independently represents an electron withdrawing group selected from the group consisting of hydrogen, an alkyl group, a halogen group, a cyano group and a nitro group, and at least one of X and Y represents an electron withdrawing group selected from the group consisting of a halogen group, a cyano group and a nitro group.

10. The secondary battery according to claim 9, wherein
the compound represented by the formula (3) is vinylene carbonate, and the compound represented by the formula (4) is 4-fluoroethylene carbonate or 4,5-difluoroethylene carbonate.

11. The secondary battery according to claim 1, wherein
the electrolytic solution further contains at least one kind of compounds represented by the following formulae (5) to (7): 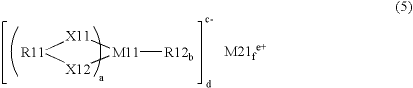
wherein
R11 represents a —C(═O)—R21—C(═O)— group, wherein R21 represents an alkylene group, a halogenated alkylene group, an arylene group or a halogenated arylene group, a —C(═O)—C(R23)(R24)— group, wherein R23 and R24 each represents an alkyl group, a halogenated alkyl group, an aryl group or a halogenated aryl group, or a —C(═O)—C(═O)— group;
R12 represents a halogen group, an alkyl group, a halogenated alkyl group, an aryl group or a halogenated aryl group,
X11 and X12 each represents oxygen or sulfur,
M11 represents a transition metal or an element belonging to the 3B group, 4B group or 5B group of the short period type periodic table,
M21 represents an element belonging to the 1A group or 2A group of the short period type periodic group or aluminum,
a represents an integer of from 1 to 4,
b represents an integer of from 0 to 8, and
c, d, e and f each represents an integer of from 1 to 3,
LiN(CₘF₂ₘ₊₁SO₂)(CₙF₂ₙ₊₁SO₂_{_{—}}) (6)
wherein m and n each represents an integer of 1 or more, and 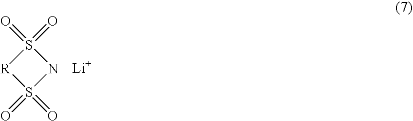
wherein R represents a linear or branched perfluoroalkylene group having from 2 to 4 carbon atoms.

12. The secondary battery according to claim 1, wherein
the electrolytic solution contains at least one kind of lithium bisoxalate borate, lithium difluorooxalate borate, lithium bis(trifluoromethanesulfonyl)imide, lithium bis(perfluoroethanesulfonyl)imide and perfluoropropane-1,3-disulfonylimide lithium.

13. The secondary battery according to claim 1, further comprising:
a PTC element in which when an excess current flows, a resistivity value thereof increases; and
an electric power lead-through plate which when a gas pressure in the inside of the battery increases to reach a prescribed pressure or more, is deformed to shut down the current into the PTC element.
